(19) United States
(12) Patent Application Publication
(10) Pub. No.: US 2006/0068969 A1
(43) Pub. Date: Mar. 30, 2006

(54) Transmission having an electronically controlled main relief valve

(75) Inventor: Christopher P. Bartsch, Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 10/949,572

(22) Filed: Sep. 27, 2004

(51) Int. Cl. F16H 61/26

(52) U.S. Cl. 477/34

(57) ABSTRACT

A transmission is provided for a work machine. The transmission has a reservoir configured to hold a supply of fluid and a source configured to pressurize the fluid. The transmission also has a manifold configured to receive the pressurized fluid and a plurality of control valves fluidly communicating with the manifold in parallel relation. The transmission further has a main pressure relief valve in fluid communication with the manifold and the reservoir. The main pressure relief valve has a valve element that is movable between a first position where fluid is allowed to flow from the manifold to the reservoir and a second position where fluid is blocked from flowing to from the manifold to the reservoir. The transmission additionally has a controller in communication with the main pressure relief valve. The controller is configured to selectively move the valve element between the first and second positions.

### TECHNICAL FIELD

The present disclosure relates generally to a transmission and, more particularly, to a transmission having an electronically controlled main relief valve.

### BACKGROUND

A work machine such as, for example, an off-highway truck, a loader, a motor grader, or any other work machine known in the art may include a multi-speed bidirectional transmission that has one or more hydraulically actuated friction clutches. These clutches may be selectively engaged to produce a predetermined output ratio of the transmission in either a forward or reverse direction. Clutches of this type may include actuators fluidly connected to a main relief valve, which is configured to control a pressure of a hydraulic fluid supplied to the actuators by allowing a flow of fluid to bypass the actuators at a predetermined pressure.

During operation of the fluid actuators, fluid pressures within the transmission may rise and fall abruptly causing vibrations within the transmission. These vibrations can cause damage to the transmission or work machine and may be a nuisance to the work machine operator. Attempts have been made to reduce these vibrations by more accurately controlling the pressure of the fluid supplied to the clutches.

One attempt to control this fluid pressure is described in Japanese Patent Publication No. H7-280081 (the '081 publication) to Aoyama. The '081 publication teaches a transmission system having an electronic control unit (ECU), a pump, a fluid-actuated clutch, and an electromagnetic pressure regulating valve configured to control a pressurized fluid supplied to the clutch. The ECU is configured to monitor a throttle opening, a vehicle speed, and a turbine rotating speed. The ECU is further configured to control a rate of pressure change of the fluid supplied to the clutch in response to the rate of change of the throttle opening, vehicle speed, and turbine rotating speed. For example, the lower the rate of change of the throttle opening, vehicle speed, and turbine rotating speed during upshifting, the greater the time during which the ECU changes the pressure of the fluid supplied to the clutch. Similarly, the greater the rate of change of the throttle opening, vehicle speed, and turbine rotating speed during upshifting, the shorter the time during which the ECU changes the pressure of the fluid supplied to the clutch.

Although the transmission system of the '081 publication may sufficiently control the pressure of fluid supplied to one clutch during shifting to help smooth transmission operation, it may be insufficient for accommodating pressure fluctuations created by multiple clutches in common fluid communication. Further, because the transmission system of the '081 publication continuously modifies the duration of pressure modulation, the transmission system may produce inconsistent shifting, which may be undesirable in some situations. In addition, the transmission system of the '081 publication may be unable to accommodate shift changes caused by temperature fluctuations within the transmission.

The disclosed transmission is directed to overcoming one or more of the problems set forth above.

### SUMMARY OF THE INVENTION

In one aspect, the present disclosure is directed to a transmission that includes a reservoir configured to hold a supply of fluid and a source configured to pressurize the fluid. The transmission also includes a manifold configured to receive the pressurized fluid and a plurality of control valves fluidly communicating with the manifold in parallel relation. The transmission further includes a main pressure relief valve in fluid communication with the manifold and the reservoir. The main pressure relief valve has a valve element that is movable between a first position where fluid is allowed to flow from the manifold to the reservoir and a second position where fluid is blocked from flowing from the manifold to the reservoir. The transmission additionally includes a controller in communication with the main pressure relief valve. The controller is configured to selectively move the valve element between the first and second positions.

In another aspect, the present disclosure is directed to a method of operating a transmission that includes pressurizing a fluid and directing the pressurized fluid through a manifold to a plurality of control valves fluidly communicating with the manifold in parallel relation. The method further includes electronically actuating a main pressure relief valve to selectively pass the pressurized fluid to a reservoir.

### BRIEF DESCRIPTION OF THE DRAWINGS

FIG. 1 is a diagrammatic illustration of a work machine having an exemplary disclosed transmission; and

FIG. 2 is a schematic illustration of an exemplary disclosed hydraulic circuit for the transmission of FIG. 1.

### DETAILED DESCRIPTION

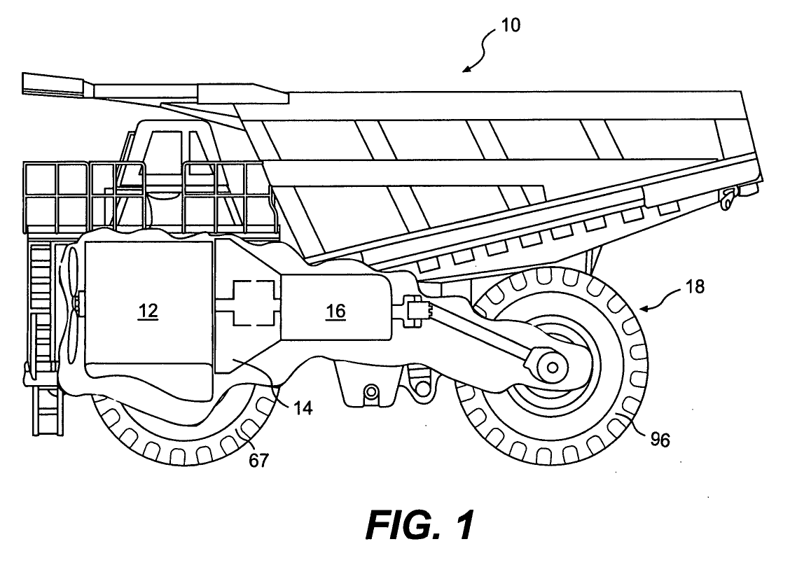

FIG. 1 illustrates an exemplary work machine 10. Work machine 10 may be a fixed or mobile machine that performs some type of operation associated with an industry such as mining, construction, farming, transportation, or any other industry known in the art. For example, work machine 10 may be an earth moving machine such as an off-highway truck, a loader, a motor grader, or any other earth moving machine. Work machine 10 may alternately be a pump, a marine vessel, a passenger vehicle, or any other suitable operation-performing work machine. Work machine 10 may include a power source 12, a torque converter 14, and a transmission 16 operably connected to a traction device 18.

Power source 12 may be configured to produce a power output and may include an internal combustion engine such as, for example, a diesel engine, a gasoline engine, a natural gas engine, or any other engine apparent to one skilled in the art. Power source 12 may, alternately, include another source of power such as a furnace, a battery, a fuel cell, or any other source of power known in the art.

Torque converter 14 (referring to FIG. 1) may be a hydraulic device configured to couple transmission 16 to power source 12. Torque converter 14 may allow power source 12 to rotate somewhat independently of transmission 16. It is contemplated that torque converter 14 may alternately be embodied in a non-hydraulic device such as, for example, a mechanical diaphragm clutch.

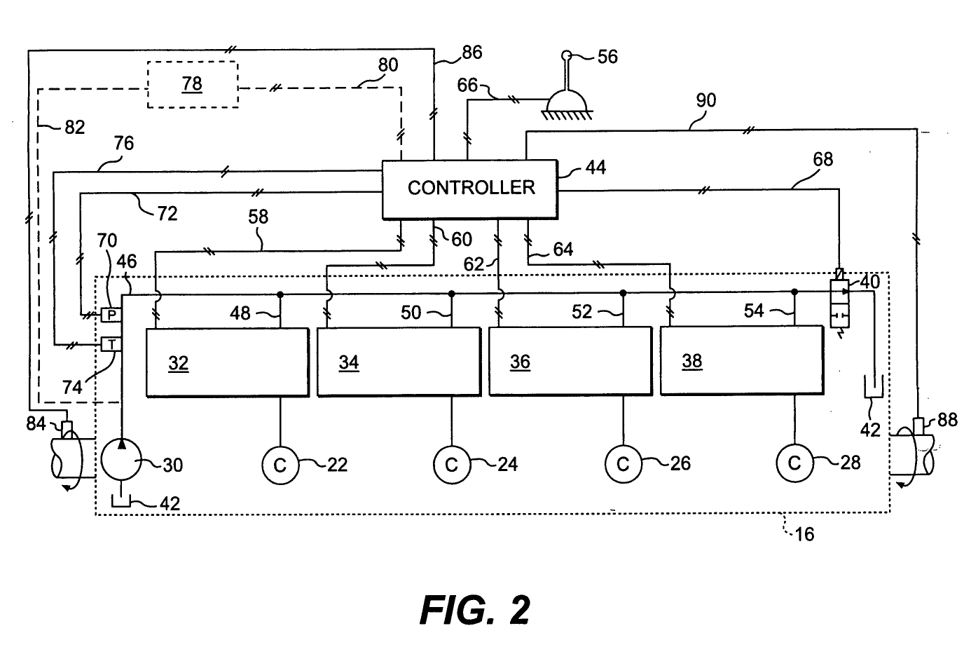

As illustrated in FIG. 2, transmission 16 may include numerous components that interact to transmit power from power source 12 to traction device 18. In particular, transmission 16 may be a multi-speed bidirectional mechanical transmission having a plurality of fluid activated clutches and control valves. In one embodiment, transmission 16 includes four clutches 22, 24, 26, 28 fluidly connected to a pump 30 through four control valves 32, 34, 36, 38. It is contemplated that additional or fewer clutches and/or control valves may be included within transmission 16. Transmission 16 may also include a main pressure relief valve (MPRV) 40, a fluid reservoir 42, and a controller 44.

Clutches 22-28 may be configured to selectively receive pressurized fluid from pump 30 causing engagement of portions of a gear train (not shown) within transmission 16. Each of clutches 22-28 may be fluidly connected to pump 30 in parallel relation by way of a manifold 46 and distribution lines 48, 50, 52, and 54, respectively. Each of clutches 22-28 may include an interior actuating chamber (not shown) that, when filled with pressurized fluid, displaces a piston (not shown), moving the piston toward one or more clutch disks (not shown) and plates (not shown), also known as a clutch pack. As the piston “touches up” to the clutch pack, the actuating chamber is full of fluid and the clutch is engaged. The combination of engaged clutches determines the output speed ratio of transmission 16.

Pump 30 may be configured to produce a flow of pressurized fluid and may include a variable displacement pump, a fixed displacement pump, a variable flow pump, or any other source of pressurized fluid known in the art. Pump 30 may be drivably connected to power source 12 by, for example, a countershaft (not shown), a belt (not shown), an electrical circuit (not shown), or in any other suitable manner. It is contemplated that pump 30 may alternately be drivably connected to transmission 16. Pump 30 may be dedicated to supplying pressurized fluid only to transmission 16, or alternately may supply pressurized fluid to both transmission 16 and one or more hydraulic systems within power source 12.

Control valves 32-38 may be disposed within distribution lines 48-54, respectively, between clutches 22-28 and manifold 46, and configured to regulate a flow of pressurized fluid to the interior actuating chambers of clutches 22-28. Specifically, each of control valves 32-38 may include a two-position valve mechanism (not shown) that is solenoid actuated and configured to actuate one of clutches 22-28. Each of the two-position valve mechanisms may be movable between a first position at which fluid is allowed to flow into an associated actuating chamber and a second position at which fluid flow is blocked from the actuating chamber. It is contemplated that more than one clutch may be associated with a single control valve. It is further contemplated that each control valve may include additional or different mechanisms such as, for example, a proportional valve, a pilot valve configured to control a pressure of the fluid entering the two-position valve mechanism and interior actuating chamber of the associated clutch or clutches, or any other mechanisms known in the art.

MPRV 40 may be an electronically actuated proportional control valve disposed downstream of manifold 46 and configured to selectively pass fluid to reservoir 42. Specifically, MPRV 40 may include a valve element (not shown) that is spring biased toward a flow blocking position and movable by a solenoid toward a flow passing position. It is contemplated that the valve element of MPRV 40 may alternately be spring biased toward a flow passing position and movable by a solenoid toward a flow blocking position. It is also contemplated that MPRV 40 may alternately be located upstream of manifold 46, within manifold 46, or in any other suitable location.

Reservoir 42 may constitute a tank configured to hold a supply of fluid. The fluid may include, for example, an engine lubrication oil, a transmission lubrication oil, a separate hydraulic oil, or any other fluid known in the art. One or both of power source 12 and transmission 16 may draw fluid from and return fluid to reservoir 42. It is also contemplated that power source 12 and transmission 16 may be connected to separate fluid reservoirs.

Controller 44 may be embodied in a single microprocessor or multiple microprocessors that include a means for controlling an operation of transmission 16. Numerous commercially available microprocessors can be configured to perform the functions of controller 44. It should be appreciated that controller 44 could readily be embodied in a general work machine microprocessor capable of controlling numerous work machine functions. Controller 44 may include all the components required to run an application such as, for example, a memory, a secondary storage device, and a processor, such as a central processing unit or any other means known in the art for controlling the work machine. Various other known circuits may be associated with controller 44, including power supply circuitry, signal-conditioning circuitry, solenoid driver circuitry, communication circuitry, and other appropriate circuitry.

Controller 44 may be configured to actuate control valves 32-38 in response to a signal from an input device 56. Specifically, controller 44 may be in communication with control valves 32-38 via communication lines 58, 60, 62, and 64, respectively, and with input device 56 via a communication line 66. Input device 56 may be disposed within an operator cabin of work machine 10 and configured to generate a signal indicative of a desired transmission output speed ratio. Controller 44 may receive the signal generated by input device 56 in response to an operator input and actuate one or more of control valves 32-38 to fill the actuating chambers associated with specific clutches 22-28 to produce the desired transmission output speed ratio. It is also contemplated that the operator input may alternately designate a maximum transmission output speed ratio and that controller 44 may automatically actuate one or more of control valves 32-38 in response to an input transmission speed or fluid pressure input to produce a transmission output speed ratio less than the maximum.

Controller 44 may also be in communication with MPRV 40 and configured to cause MPRV 40 to pass fluid to reservoir 42 in conjunction with the operation of control valves 32-38. Specifically, controller 44 may be in communication with MPRV 40 via a communication line 68. Controller 44 may energize the solenoid of MPRV 40 to move the valve element of MPRV 40 toward the flow passing position or de-energize the solenoid to allow the valve element to move toward the flow blocking position. As the valve element of MPRV 40 moves towards the flow blocking position, the pressure of the fluid within manifold 46 increases. As the valve element of MPRV 40 moves towards the flow passing position, the pressure of the fluid within manifold 46 decreases. The pressure within manifold 46 may control both a fill time of an actuated clutch, as well as a force that the actuated clutch exerts on the associated gear train.

Controller 44 may be configured to receive one or more transmission inputs and to control actuation of control valves 32-38 and/or MPRV 40 in response to the inputs. In particular, controller may be in communication with a pressure sensor 70 via a communication line 72, in communication with a temperature sensor 74 via a communication line 76, in communication with a transmission input speed sensor 84 via a communication line 86, and in communication with a transmission output speed sensor 88 via a communication line 90. Pressure and temperature sensors 70, 74 may be disposed in any suitable location within transmission 16 and may be configured to generate signals indicative of a pressure and temperature of the pressurized fluid within transmission 16. Transmission input and output speed sensors 84, 88 may disposed on input and output shafts of transmission 16, respectively. It is also contemplated that transmission input and/or output speed sensors 84, 88 may be disposed in locations other than input and output shafts of transmission 16 such as, for example on a drive member of power source 12 (input speed sensor), on a driven member of traction device 18 (output speed sensor), or in any other suitable location. Transmission input and output speed sensors 84, 88 may be magnetic pickup type sensors configured to generate signals indicative of input and output rotational speeds of transmission 16, respectively. Controller 44 may be configured to actuate control valves 32-38 and/or MPRV 40 in response to a pressure of the fluid within manifold 46, a temperature of the fluid within manifold 46, and a speed differential within transmission 16.

In one embodiment, the pump of transmission 16 may also be connected via a fluid passageway 82 to a hydraulic system 78 for supplying pressurized fluid to the hydraulic system in parallel relation to control valves 32-38. Hydraulic system 78 may be a work machine hydraulic system that is external to transmission 16. For example, hydraulic system 78 may be a work tool actuation system having one or more hydraulic cylinders, control valves, pressure regulators, and/or other hydraulic mechanisms known in the art. Controller 44 be in communication with hydraulic system 78 via a communication line 80 and configured to receive one or more inputs from hydraulic system 78 and to control actuation of control valves 32-38 and/or MPRV 40 in response to the inputs. It is contemplated that hydraulic system 78 may alternately be completely separated from the fluid circuit of transmission 16 or may be absent, if desired.

Traction device 18 (referring to FIG. 1) may include wheels 96 located on each side of work machine 10 (only one side shown). Alternately, traction device 18 may include tracks, belts or other driven traction devices. Traction device 18 may be driven by transmission 16 to rotate in accordance with an output rotation of transmission 16.

### INDUSTRIAL APPLICABILITY

The disclosed transmission may be applicable to any work machine where consistent and responsive gear shifting, a reduction of transmission and work machine vibration, and extended transmission life is desirable. In particular, the disclosed transmission may improve shift responsiveness by maintaining desired fluid pressures supplied to control valves 32-38 and clutches 22-28 in anticipation of and during desired gear changes. The disclosed transmission may provide consistent gear shifting by accommodating pressure and temperature changes within the pressurized fluid of transmission 16. Further, the disclosed transmission may reduce pressure fluctuations and the associated vibrations by controlling movement of main pressure relief valve 40 in response to various transmission inputs. The disclosed transmission system may extend transmission life by preventing pressure fluctuations that may be damaging to components of transmission 16 and by allowing transmission 16 to operate at multiple predetermined pressure levels. In addition, the disclosed transmission may improve operation of external hydraulic systems by controlling operation of main pressure relief valve 40 in response to inputs from the external hydraulic system.

Referring to FIG. 2, when transmission 16 is in operation, pump 30 may pressurize a fluid from reservoir 42 in preparation for transmission gear engagement. When transmission 16 is in a neutral condition, fluid pressurized by pump 30 may be directed from reservoir 42 through manifold 46 to MPRV 40. While the valve element of MPRV 40 is in a flow blocking position, the fluid pressure within manifold 46 may build until it reaches a predetermined desired pressure. Upon reaching the predetermined desired pressure, controller 44 may actuate MPRV 40 to pass the pressurized fluid back to reservoir 42. The valve element of MPRV 40 may be movable to any position between the fluid passing position and the fluid blocking position to accommodate a range of predetermined desired pressures.

A work machine operator may select a desired transmission output gear ratio or a maximum transmission output speed ratio by moving input device 56. When the operator selects a particular gear ratio, a predetermined combination of one or more of control valves 32-38, which are in fluid communication with manifold 46, may actuate to allow the pressurized fluid within manifold 46 to enter associated actuation chambers, thereby engaging one or more of clutches 22-28. When the operator selects a maximum transmission output ratio, controller 44 may automatically actuate a predetermined combination of one or more of control valves 32-38, thereby engaging one or more of clutches 22-28 to produce a transmission output speed ratio less than the maximum.

During clutch filling of typical transmissions, the associated control valve opens and the pressure within the common manifold can drop below a desired pressure causing a spring actuated main pressure relief valve to close. The pressure within the manifold can then build to a level in excess of the desired pressure causing the main pressure relief valve to again open in an attempt to reach the desired pressure. This oscillation of pressure and valve movement may continue until the desired pressure is reached. Once clutch filling is complete, the control valve abruptly closes, which can cause a pressure spike within the common manifold. Operating in this manner can cause clutch actuation delay, inconsistent clutch actuation, instability (overshooting and undershoot pressure fluctuations), and possible component-damaging pressure spikes.

The disclosed transmission improves responsiveness by determining when a gear shift is desired and by determining opening and closing times of the associated control valves. Movement of the valve element of MPRV 40 may then be electronically initiated prior to or simultaneous with control valve actuation opening and closing to produce the desired fluid pressures without the associated pressure drops, spikes, or instability. For example, controller 44 may determine that a gear shift is desired and cause the valve element of MPRV 40 to move toward the flow blocking position just prior to or simultaneous with an opening of the appropriate control valve in anticipation of the increased demand for pressurized fluid. Because the movement of MPRV 40 is proactive rather than reactive, the pressure within manifold 46 may be sufficient to fill the appropriate clutch without causing a significant drop in pressure within manifold 46. In addition, because the pressure within manifold 46 does not drop significantly, the clutch may be filled more quickly. In similar manner, controller 44 may cause the valve element of MPRV 40 to move toward the flow passing position just prior to or simultaneous with a closing of the appropriate control valve. In this manner, the fluid pressure within manifold 46 may be kept from spiking.

The movement of MPRV 40 may be determined based on a shift map stored in a memory of controller 44. For example, controller 44 may compare a desired gear shift and a current fluid pressure with the shift map to determine an amount of movement and/or timing of the movement of the valve element of MPRV 40. It is contemplated that different or additional variables may be referenced with the shift map to determine positioning of the valve element of MPRV 40. It is also contemplated that the movement of MPRV 40 may alternately be calculated as a function of pressure and the desired clutch combination from one or more equations stored in the memory of controller 44.

Controller 44 may also directly control actuation of MPRV 40 based in the pressure signal from pressure sensor 70. For example, when a pressure within manifold 46, as measured by pressure sensor 70, exceeds one or more predetermined pressure thresholds, controller 44 may activate the solenoid of MPRV 40 to pass fluid from manifold 46 to reservoir 42. Likewise, when the pressure within manifold 46 drops below one or more predetermined pressure thresholds, controller 44 may deactivate the solenoid of MPRV 40 to block fluid from passing to reservoir 42. In this manner, main pressure relief valve 40 may function to maintain one or more predetermined pressure levels within manifold 46.

Controller 44 may modify actuation of MPRV 40 and/or control valves 32-38 based on a temperature signal from temperature sensor 74. The temperature of the pressurized fluid within transmission 16 can affect fill times of clutches 22-28. For example, a hot fluid at a predetermined pressure may fill a clutch cavity more quickly then a cold fluid at the same pressure. In addition, proper operation of transmission 16 may require higher pressures when the fluid is hot versus when the fluid is cold. Controller 44 may be configured to receive the temperature signal and accommodate for the differing operational characteristics of transmission 16 by responsively changing control valve opening and closing times and/or movement of MPRV 40. In this manner, controller 44 may facilitate improved consistency of clutch engagement. It is contemplated that controller 44 may modify actuation of MPRV 40 based on additional or different transmission parameters such as, for example, a viscosity or another parameter known in the art.

Controller 44 may further modify actuation of MPRV 40 to control slippage within transmission 16. Slippage can occur between a clutch and an associated gear train when a pressure of the fluid supplied to the clutch is insufficient to cause the clutch to fully engage the drive train. Controller 44 may determine that slippage is occurring by comparing a transmission input speed value from transmission input speed sensor 84 to an adjusted transmission output speed value. The transmission output speed value from transmission output speed sensor 88 may be adjusted by dividing the transmission output speed value by an engaged gear ratio. It is contemplated that controller 44 may alternately determine that slippage is occurring by comparing the transmission output speed value with an adjusted transmission input speed value. If controller 44 determines that slippage is occurring, controller 44 may then cause MPRV 40 to block additional flow of fluid through manifold 46 to increase a pressure supplied to the engaged clutch until slippage is no longer detected.

Controller 44 may improve performance of hydraulic system 78 by controlling movement of MPRV 40. For example, there may be instances when hydraulic system 78, which receives pressurized fluid from pump 30, may require additional pressure and/or flow to perform a task. In this situation, MPRV 40 may be controlled to block pressurized fluid from flowing through manifold 46 to reservoir 42 in response to an input from hydraulic system 78. The blockage of pressurized fluid through manifold 46 may then cause a build up in the pressure and/or increase a flow of the fluid supplied by pump 30 to hydraulic system 78. The inputs from hydraulic system 78 may include, among other things, a pressure, a flow rate, a temperature, a viscosity, or any other appropriate input.

It will be apparent to those skilled in the art that various modifications and variations can be made to the transmission of the present disclosure. Other embodiments of the transmission will be apparent to those skilled in the art from consideration of the specification and practice of the invention disclosed herein. For example, it is contemplated that MPRV 40 may be used in a system where control valves 32-38 are actuated in a manner other than electronically such as mechanically, hydraulically, pneumatically, or in any other suitable manner. It is intended that the specification and examples be considered as exemplary only, with a true scope of the invention being indicated by the following claims and their equivalents.

What is claimed is:

1. A transmission, comprising:
a reservoir configured to hold a supply of fluid;
a source configured to pressurize the fluid;
a manifold configured to receive the pressurized fluid;
a plurality of control valves fluidly communicating with the manifold in parallel relation;
a main pressure relief valve in fluid communication with the manifold and the reservoir, the main pressure relief valve having a valve element movable between a first position where fluid is allowed to flow from the manifold to the reservoir and a second position where fluid is blocked from flowing to from the manifold to the reservoir; and
a controller in communication the main pressure relief valve and configured to selectively move the valve element between the first and second positions.

2. The transmission of claim 1, wherein the controller is in further communication with each of the plurality of control valves and configured to selectively actuate the plurality of control valves in response to a predetermined condition.

3. The transmission of claim 2, wherein the predetermined condition is related to a desired transmission output gear ratio input by an operator.

4. The transmission of claim 2, wherein the predetermined condition is related to a transmission input speed.

5. The transmission of claim 2, further including a temperature sensor configured to generate a signal indicative of a temperature of the pressurized fluid, wherein the controller is in communication with the temperature sensor and configured to modify actuation of the plurality of control valves in response to the signal.

6. The transmission of claim 2, wherein the controller is further configured to move the valve element toward the second position prior to actuation of the plurality of control valves.

7. The transmission of claim 6, wherein the controller is further configured to move the valve element toward the first position prior to completion of actuation of the plurality of control valves.

8. The transmission of claim 2, wherein the controller is further configured to move the valve element toward the second position simultaneous with actuation of the plurality of control valves.

9. The transmission of claim 8, wherein the controller is further configured to move the valve element toward the first position simultaneous with completion of actuation of the plurality of control valves.

10. The transmission of claim 1, further including a temperature sensor configured to generate a signal indicative of a temperature of the fluid, wherein the controller is in communication with the temperature sensor and configured to modify movement of the valve element in response to the signal.

11. The transmission of claim 1, further including a plurality of fluid actuated clutches, each of the fluid actuated clutches being associated with one of the plurality of control valves.

12. The transmission of claim 11, further including:
a plurality of gear trains, each of the plurality of gear trains being associated with one of the plurality of fluid actuated clutches;
a transmission input speed sensor; and
a transmission output speed sensor,
wherein the controller is in communication with the transmission input and output sensors, configured to determine when slippage occurs between the plurality of gear trains and the plurality of fluid actuated clutches, and configured to move the valve element toward the first position when slippage occurs.

13. The transmission of claim 1, further including a pressure sensor configured to generate a signal indicative of a pressure of the fluid, wherein the controller is configured to move the valve element in response to the signal.

14. The transmission of claim 1, wherein the supply of fluid and the source are common with a hydraulic system external to the transmission, the controller is in communication with the hydraulic system, and the controller is configured to move the valve element in response to an input from the hydraulic system.

15. A method of operating a transmission, comprising:
pressurizing a fluid;
directing the pressurized fluid through a manifold to a plurality of control valves fluidly communicating with the manifold in parallel relation; and
electronically actuating a main pressure relief valve to selectively pass the pressurized fluid to a reservoir.

16. The method of claim 15, further including selectively actuating at least one of a plurality of control valves to fill at least one of a plurality of clutches with pressurized fluid in response to a predetermined condition.

17. The method of claim 16, wherein the predetermined condition is related to a desired transmission output gear ratio input by an operator.

18. The method of claim 16, wherein the predetermined condition is related to a transmission input speed.

19. The method of claim 16, further including:
sensing a temperature of the pressurized fluid and generating a signal indicative of the temperature; and
modifying actuation of the plurality of control valves in response to the signal.

20. The method of claim 16, wherein the main pressure relief valve has a valve element movable between a first position where fluid is allowed to flow from the manifold to the reservoir and a second position where fluid is blocked from flowing to from the manifold to the reservoir, and the method further includes moving the valve element toward the second position prior to actuation of the plurality of control valves.

21. The method of claim 20, further including moving the valve element toward the first position prior to completion of actuation of the plurality of control valves.

22. The method of claim 16, wherein the main pressure relief valve has a valve element movable between a first position where fluid is allowed to flow from the manifold to the reservoir and a second position where fluid is blocked from flowing to from the manifold to the reservoir, and the method further includes moving the valve element toward the second position simultaneous with actuation of the plurality of control valves.

23. The method of claim 22, further including moving the valve element toward the first position simultaneous with completion of actuation of the plurality of control valves.

24. The method of claim 15, further including:
sensing a temperature of the pressurized fluid and generating a signal indicative of the temperature; and
modifying actuation of the main pressure relief valve in response to the signal.

25. The method of claim 15, wherein the main pressure relief valve has a valve element movable between a first position where fluid is allowed to flow from the manifold to the reservoir and a second position where fluid is blocked from flowing to from the manifold to the reservoir, and the method further includes:
sensing a input speed of the transmission and generating a signal indicative of the input speed;
sensing an output speed of the transmission and generating a signal indicative of the output speed;
comparing the input speed signal and the output speed signal to determine slippage between a plurality of gear trains and a plurality of fluid actuated clutches; and
moving the valve element toward the first position when slippage occurs.

26. The method of claim 15, further including:
sensing a pressure of the pressurized fluid and generating a signal indicative of the pressure; and
actuating the main pressure relief valve in response to the signal.

27. The method of claim 15, wherein the pressurized fluid is common with a hydraulic system external to the transmission, and the method further includes:
receiving an input from the hydraulic system; and
actuating the main pressure relief valve in response to the input.

28. A work machine, comprising:
a power source operable to generate a power output;
a traction device; and
a transmission configure to transmit the power output from the power source to the traction device, the transmission including:
a reservoir configured to hold a supply of fluid;
a source configured to pressurize the fluid;
a manifold configured to receive the pressurized fluid;
a plurality of control valves fluidly communicating with the manifold in parallel relation;
a main pressure relief valve in fluid communication with the manifold and the reservoir, the main pressure relief valve having a valve element movable between a first position where fluid is allowed to flow from the manifold to the reservoir and a second position where fluid is blocked from flowing from the manifold to the reservoir; and
a controller in communication the main pressure relief valve and configured to selectively move the valve element between the first and second positions, the controller being in further communication with each of the plurality of control valves and configured to selectively actuate the plurality of control valves in response to a predetermined condition.

29. The work machine of claim 28, wherein the predetermined condition is related to a desired transmission output gear ratio input by an operator.

30. The work machine of claim 28, wherein the predetermined condition is related to a transmission input speed.

31. The work machine of claim 28, further including a temperature sensor configured to generate a signal indicative of a temperature of the fluid, wherein the controller is in communication with the temperature sensor and configured to modify actuation of the plurality of control valves in response to the signal.

32. The work machine of claim 28, wherein the controller is further configured to move the valve element toward the second position prior to actuation of the plurality of control valves.

33. The work machine of claim 32, wherein the controller is further configured to move the valve element toward the first position prior to completion of actuation of the plurality of control valves.

34. The work machine of claim 28, wherein the controller is further configured to move the valve element toward the second position simultaneous with actuation of the plurality of control valves.

35. The work machine of claim 34, wherein the controller is further configured to move the valve element toward the first position simultaneous with completion of actuation of the plurality of control valves.

36. The work machine of claim 28, further including a temperature sensor configured to generate a signal indicative of a temperature of the fluid, wherein the controller is in communication with the temperature sensor and configured to modify movement of the valve element in response to the signal.

37. The work machine of claim 28, further including:
a plurality of fluid actuated clutches, each of the fluid actuated clutches being associated with one of the plurality of control valves;
a plurality of gear trains, each of the plurality of gear trains being associated with one of the plurality of fluid actuated clutches;
a transmission input speed sensor; and
a transmission output speed sensor,
wherein the controller is in communication with the transmission input and output sensors, configured to determine when slippage occurs between the plurality of gear trains and the plurality of fluid actuated clutches, and configured to move the valve element toward the first position when slippage occurs.

38. The work machine of claim 28, further including a pressure sensor configured to generate a signal indicative of a pressure of the fluid, wherein the controller is configured to move the valve element in response to the signal.

39. The work machine of claim 28, further including a hydraulic system external to the transmission and configured to receive pressurized fluid from the source, wherein the controller is in communication with the hydraulic system and configured to move the valve element in response to an input from the hydraulic system.

40. A transmission comprising:
a reservoir configured to hold a supply of fluid;
a source configured to pressurize the fluid;
a manifold configured to receive the pressurized fluid;
a plurality of control valves fluidly communicating with the manifold in parallel relation; and
a means for selectively passing pressurized fluid from the manifold to the reservoir.
